(19) United States
(12) Patent Application Publication
(10) Pub. No.: US 2011/0112823 A1
(43) Pub. Date: May 12, 2011

(54) Ellipsis and movable constituent handling via synthetic token insertion

(75) Inventor: Tatu J. Ylonen, Espoo (FI)

(73) Assignee: TATU YLONEN OY LTD, Espoo (FI)

(21) Appl. No.: 12/613,874

(22) Filed: Nov. 6, 2009

(51) Int. Cl. G06F 17/27

(52) U.S. Cl. 704/9

(57) ABSTRACT

Movable and elliptic constituents are handled in a parser by inserting synthetic tokens that do not occur in the input. Parser actions can push a syntax tree or semantic value to be realized later as a synthetic token, and some synthetic tokens (for cataphoric ellipsis) may be inserted without a prior push but require a later definition. At clause boundary it may be checked that all mandatory tokens have been inserted.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to computational linguistics, particularly parsing natural language by a computer.

### BACKGROUND OF THE INVENTION

Dozens if not hundreds of parsing techniques and formalisms are known for natural language parsing. Many of these techniques are usually implemented using a context-free core (or backbone) and some kind of unification mechanism or other mechanisms for handling long-distance constraints and transformations or movements of constituents.

Many efficient parsing techniques are known for context-free grammars or their subsets, including LR parsers, LL parsers, LALR parsers, chart parsers, Tomita (GLR) parsers, etc. Detailed descriptions of LR and LL parsing can be found from A. Aho: Compilers: Principles, Techniques and Tools, Addison-Wesley, 1986; it also contains a description of finite automata and their use for parsing grammars. LALR lookahead set construction is described in F. DeRemer and T. Pennello: Efficient Computation of LALR(1) Look-Ahead Sets, ACM Transactions on Programming Languages and Systems, 4(4):615-649, 1982. Generalized LR parsing is described in M. Tomita: Efficient Parsing for Natural Language: A Fast Algorithm for Practical Systems, Kluwer, 1986 and M. Tomita: Generalized LR Parsing, Kluwer, 1991. Newer approaches can be found in H. Bunt et al: New Developments in Parsing Technology, Kluwer, 2004. G. Richie et al: Computational Morphology, MIT Press, 1992 describes a complete parsing system with a morphological analyzer and a syntactic parser. Left-corner chart parsing is described in R. Moore: Improved Left-Corner Chart Parsing, in H. Bunt et al (eds.): New Developments in Parsing Technology, Kluwer, 2004, pp. 185-201, and references contained therein. Chart parsing of word lattices is described in C. Collins et al: Head-Driven Parsing for Word Lattices, ACL'04, Association for Computational Linguistics (ACL), 2004, pp. 232-239.

Context-free grammars were long considered unsuitable for parsing natural language, as there are various long-distance and coherence effects that are difficult to model using context-free grammars. Also, it has been difficult to handle ellipsis and various fronted constituents with context-free grammars.

However, unification parsers enjoyed considerable success. They are sometimes built directly on top of context-free grammars by augmenting context-free grammars using unification actions. They may also be completely separate formalisms where parsing rules often look like unification rules, but the actual implementation of the parser is, for performance reasons, usually using some kind of context-free core on top of which unification actions are performed. Examples can be found in T. Briscoe and J. Carroll: Generalized Probabilistic LR Parsing of Natural Language (Corpora) with Unification-Based Grammars, Computational Linguistics, 19(1):25-59, 1993 and M. Kay: Parsing in functional unification grammar, in D. Dowty et al (eds.): Natural Language Parsing, Cambridge University Press, 1985, pp. 251-278.

Considerable success has also been enjoyed by finite-state parsers, where many more rules and much larger parsing automata (typically multiple separate automata running in parallel with intersection semantics) are used to implement a grammar. Finite state parsing of natural language is described, e.g., in F. Karlsson et al: Constraint Grammar, Mouton de Gruyter, 1994; E. Roche and Y. Schabes (eds.): Finite-State Language Processing, MIT Press, 1997; and A. Kornai (eds.): Extended Finite State Models of Language, Cambridge University Press, 1999.

A drawback of unification parsers is the high overhead due to generic unification and construction of feature structures. A drawback of finite state parsers is that they require large numbers of highly complex and interacting rules that are difficult to write and maintain. To some degree the same also applies to many unification formalisms.

Many parsers are designed to produce parse trees. Finite state parsers typically do not produce parse trees, though they may label words for constructing a dependency graph. Unification parsers frequently produce a feature structure that represents the parse. Various other parsers produce parse trees or abstract syntax trees (AST) that display the constituent structure or the logical structure of the input. Some parsers include various actions for moving subtrees in the resulting parse trees such that constituents that are not in their canonical positions can be handled. Some parsers directly produce a semantic representation (e.g., a semantic network) of the input (see, e.g., S. Hartrumpf: Hybrid Disambiguation in Natural Language Analysis, Der Andere Verlag, 2003).

Nodes in parse trees are sometimes labeled by synthetic tokens, which are tokens that were not generated by the lexical analyzer (i.e., were not present in the input). Synthetic tokens are also sometimes used for particulars of the input detected by the lexical analyzer but not represented by real (printable) input characters, such as increase or decrease in indentation (when analyzing an indentation-sensitive programming language such as Python), beginning of a new field when parsing structured data, etc. Some parsing systems provide a function that can be used to insert a synthetic token into the tokenized input at the current position. Some macro facilities can also be seen as creating synthetic tokens, i.e., tokens that do not occur in the input.

Elliptic constituents (i.e., constituents that are realized as zero, that is, omitted from a clause) are a universal phenomenon in natural languages, and cannot be considered to be in the periphery of the language. It is also not uncommon for languages to have constructs where a constituent appears elliptically deeply embedded in a clause structure, and such constructions can be very common and productive. In English, for instance, an elliptic or moved constituent can occur in a wide variety of positions, such as in “The man I saw him give the book to < > after dinner is here again”, “Whom did you give it to < >?”, or “Whom did your brother see your mother give a kiss < > last Christmas?”. Also, discourse structure may cause certain constituents to be fronted.

Various proposals and solutions have been devised for handling such movements or elliptic constituents; however, they typically add significantly to the complexity of parsers. One solution for handling elliptic expressions has been presented in R. Kempson et al: Dynamic Syntax: The Flow of Language Understanding, Blackwell Publishers, 2001. It defines a formal model for left-to-right processing of natural language, and operates largely using a deductive formalism. Other solutions include the use of transformations (as in transformational grammar), movement roles, and various tree joining and tree restructuring strategies.

It would be desirable to find an efficient practical solution for handling elliptic constituents, relative clause heads, fronted constituents and the like without unduly complicating the grammar.

The references mentioned herein are hereby incorporated herein by reference.

### BRIEF SUMMARY OF THE INVENTION

A natural language parser is extended for handling movable constituents, anaphoric ellipsis, and cataphoric ellipsis by synthetic token insertions and parser actions for controlling and constraining their use. The parser is preferably a generalized LR parser with unification, though other parsing formalisms could also be used analogously, particularly if they operate left-to-right or incrementally. The invention can also be applied to other parsing formalisms if they are implemented using a core that can handle synthetic token insertions and can implement the required control mechanisms (whether using actions associated with rule reduction, actions associated with transitions, or using actions triggered in some other manner suited to the particular parser implementation).

In general, mechanisms are added for inserting one or more synthetic tokens that do not occur in the input text (at least not at that location) into the parser's input stream of terminal tokens before processing each real terminal token (including the end-of-text or EOF token) and for controlling when synthetic tokens can be inserted. Such insertions are constrained by the grammar and other restrictions described herein, as well as the described parser actions. An insertion may incur a penalty in, e.g., weighted or best-first parsers.

For moved (typically fronted) constituents, the moved constituent may be pushed to a synthetic item set as a token that must be inserted within the current clause. When the constituent is inserted, it is removed from the set. At clause boundary, it is checked that the set does not contain any constituents that should have been inserted in the preceding clause, and the parse is rejected if it does. The moved constituent may then be represented in the grammar in, e.g., prepositional phrases or object positions using the synthetic token as an alternative to its normal syntax. For moved constituents, the constituent would typically not be made part of a parse tree or semantic representation at its original location, but only where it is inserted (for relative heads, it would often be included in the parse tree at both sites). Such constituents could be used, e.g., for implementing passive, questions, and many types of relative clauses, such as ([ ] indicates the moved/copied constituent, and < > where it is inserted):
[A horse] was seen <a horse> galloping in the middle of the city.
[Whom] did you see <whom>?
[Which booth] did you say he went to <which booth> at the exhibition?
[The man] I saw <the man> had a big hat.

For anaphorically elliptic constituents, a parser action may be used to push a parsed constituent (e.g., subject, auxiliary, main verb) into the synthetic item set as a token that may be inserted in the next clause. Such constituents do not cause the parse to be rejected at clause or sentence boundary, even if they have not been inserted. For example:
[She] saw me and <she> smiled.
[I] met her and <I> told her about the plan.
[I] [saw] him but <I> <saw> not her.
[I] [have been] hunting for rabbits but <I> <have been> finding only squirrels.

For cataphorically elliptic constituents, a synthetic token identified as cataphoric may be inserted at any time (unless it is already in the synthetic item set) and added to the synthetic item set, and it may later be defined by a parser action, causing the original use to refer to the later definition (at which point the token may be removed from the set or changed to a different type of token). Examples of cataphorically elliptic cases include:
The bear caught < > and ate [a trout].
He saw < > and greeted [me].

Parser actions at clause boundaries and sentence boundaries are used to check that the synthetic item set does not contain certain types of constituents and remove certain types of constituents from it.

Further actions may be used at relative clause boundaries to change how the clause boundary constraints operate. In some languages, movable constituents may move across relative clauses or may be inserted within them, and thus the parse should not be rejected by clause boundaries within the relative clause.

A first aspect of the invention is a system comprising:
a left-to-right parser executor for natural language;
a synthetic token insertion means configured to insert a synthetic token to be processed by the left-to-right parser executor; and
at least one synthetic define means coupled to the synthetic token insertion means.

A system can be, for example, a computer or system comprising a computer, such as a robot comprising a natural language interface for interacting with the environment, an intelligent control means enabling it to perform operations at least partially autonomously, a sensor means such as a camera and a real-time image analysis module for obtaining information about the environment, a movement means such as legs or wheels, a manipulation means such as hands or grippers, and a power source. The left-to-right parser executor may be implemented using a dedicated computer within the system or may share the same computer with other functions, such as motion planning, on the system.

A left-to-right parser is a parser that processes the input in the left-to-right direction (though it may sometimes return to an earlier position to pursue alternative parses). Examples of such parsers are LR(k), LL(k), and LALR(k) parsers (usually used in a non-deterministic fashion). The term also includes chart parsers which process the input left-to-right. A generalized LR parser is a non-deterministic LR parser. They were described in Tomita (1986) and Tomita (1991), though other variants of generalized LR parsers are also possible. For example, generalized LALR(1) parsers have been used (see, e.g., T. Briscoe: The Second Release of the RASP System, Proceedings of the COLING/ACL 2006 Interactive Presentation Sessions, Association for Computational Linguistics (ACL), 2006, pp. 77-80). In this specification, a generalized LR parser means any deterministic or non-deterministic LR(k) parser variant. Some generalized LR parsers use a graph-structured stack, some do not.

A second aspect of the invention is a method of parsing natural language using a left-to-right parser executor in a computer, comprising:
adding, by a parser action performed by the parser executor after parsing a non-synthetic constituent, an item specifying a synthetic token and a value from the non-synthetic constituent into a synthetic item set; and
inserting, by the parser executor, a synthetic token specified by an item in the synthetic item set to be processed by the parser executor.

A third aspect of the invention is a method of parsing natural language using a left-to-right parser executor in a computer, comprising:
inserting, by the parser executor, a synthetic token to be processed by the parser executor; and
defining, by a parser action performed by the parser executor after parsing a non-synthetic constituent, a value associated with the inserted synthetic token based on the non-synthetic constituent.

A fourth aspect of the invention is a computer program product stored on a computer readable medium operable to cause a computer to perform left-to-right parsing of natural language, the product comprising:
a computer readable program code means for causing a computer to add an item specifying a synthetic token and a value for it into a synthetic item set; and
a computer readable program code means for causing a computer to insert a synthetic token specified by an item in the synthetic item set to be processed by the computer as part of the left-to-right parsing.

A fifth aspect of the invention is a computer program product stored on a computer readable medium operable to cause a computer to perform left-to-right parsing of natural language, the product comprising:
a computer readable program code means for causing a computer to insert a synthetic token to be processed by the computer as part of the left-to-right parsing; and
a computer readable program code means for causing a computer to define the value associated with the inserted token after parsing a non-synthetic constituent based on the non-synthetic constituent.

### BRIEF DESCRIPTION OF THE SEVERAL VIEWS OF THE DRAWING(S)

FIG. 1 illustrates a system according to an embodiment of the invention.

FIG. 2 illustrates the action means (121) according to an embodiment of the invention.

FIG. 3 illustrates LR parsing for a context-free grammar with synthetic token insertion according to an embodiment of the invention.

### DETAILED DESCRIPTION OF THE INVENTION

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, a system, or a computer program product which is an aspect of the invention may comprise any number of the embodiments or elements of the invention described in the specification. Separate references to “an embodiment” or “one embodiment” refer to particular embodiments or classes of embodiments (possibly different embodiments in each case), not necessarily all possible embodiments of the invention.

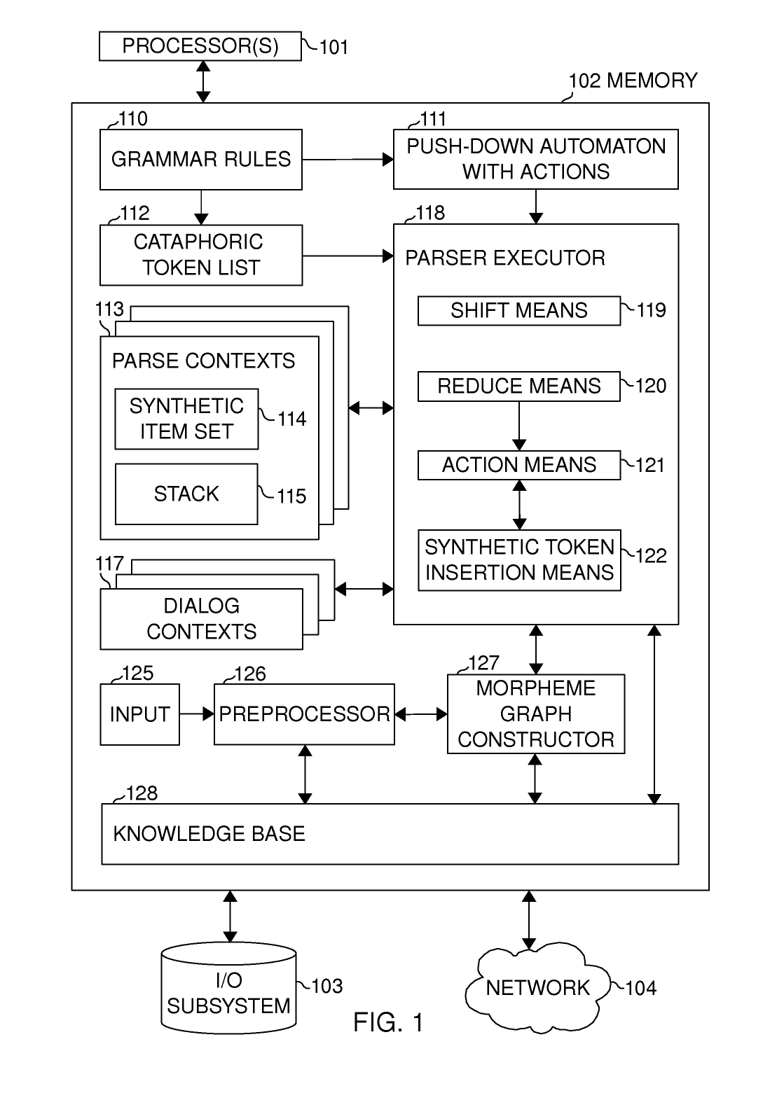

FIG. 1 illustrates a system according to a possible embodiment of the invention. (101) illustrates one or more processors. The processors may be general purpose processors, or they may be, e.g., special purpose chips or ASICs. Several of the other components may be integrated into the processor. (102) illustrates the main memory of the computer. (103) illustrates an I/O subsystem, typically comprising mass storage (such as magnetic, optical, or semiconductor disks, tapes or other storage systems, RAID subsystems, etc.; it frequently also comprises a display, keyboard, speaker, microphone, camera, and/or other I/O devices). (104) illustrates a network interface; the network may be, e.g., a local area network, wide area network (such as the Internet), digital wireless network, or a cluster interconnect or backplane joining processor boards and racks within a clustered or blade-based computer. The I/O subsystem and network interface may share the same physical bus or interface to interact with the processor(s) and memory, or may have one or more independent physical interfaces. Additional memory may be located behind and accessible through such interfaces, such as memory stored in various kinds of networked storage (e.g., USB tokens, iSCSI, NAS, file servers, web servers) or on other nodes in a distributed non-shared-memory computer.

(110) illustrates a plurality of grammar rules. These may be, e.g., context-free rules, finite-state rules, unification rules, or rules combining several formalisms. From the rules, a push-down automaton with actions (111) is generated (in some embodiments this could be a finite state automaton). The automaton may also comprise LALR lookahead sets and/or other optimization mechanisms. Such generation is well known in the art, as described in, e.g., the cited works by Aho et al (1986) and DeRemer&Pennello (1982). The actions depend on the particular unification formalism, but it is well known how to associate actions with context-free parsing rules (as is done in, e.g., the Bison and Yacc parser generators), to be executed when the rule is reduced. Actions in the middle of a rule may be implemented with a dummy action rule that matches the empty string. The actions may read and modify values on the parsing stack as well as in other data structures. Actions could also be associated with transitions or states in an automata (as is traditionally done in finite-state parsing, though such approach could also be extended to context-free parsing). Some example grammar fragments are given below:

/* object in accusative, or an elliptic or moved object */
obj ::=

np/ACC |
MOVABLE_OBJ12;

/* NPs like “the man I saw” may be handled using movable

constituents as here */

relclause ::=

...
np1/{>>,>!MOVABLE_OBJ12} svo/{<<} |
np1/{>>,>!MOVABLE_OBJ12} WH_WHOM svo/{<<} |
...

In the above example, “>>” means entering relative clause, “<<” leaving relative clause (for the clause nesting means), “>!” causes an item which must be inserted in the current clause to be added to the synthetic item set. “/” introduces actions or constraints to be associated with the previous token, and braces are used if there are multiple such constraints or actions. One way to implement these actions is to add an action rule with an empty right side right after the terminal or non-terminal symbol with actions, and have the actions be executed when the action rule is reduced (similar to the way actions are handled in Yacc and Bison).

(112) illustrates a cataphoric token list, that is, tokens that are used for cataphorically elliptic constituents. Not all grammars have cataphorically elliptic tokens, and not all embodiments support them. The grammar may indicate that some tokens are used for cataphoric ellipsis.

The push-down automaton and the cataphorically elliptic token list may be generated off-line, and not all embodiments need to have the grammar rules stored on the computer. In fact, it is anticipated that many commercial vendors will treat the grammar rules as proprietary trade secrets and will not include them in the product. It is sufficient to include the data generated from them when using GLR parsing. However, some other parsing formalisms may use the rules directly, and may not generate or require such intermediate data structures.

(113) illustrates one or more parse contexts, each corresponding to a candidate (partial) parse of the input. Since grammars for natural languages are generally ambiguous, there are usually many parse contexts. Many parsers manage the parse contexts using a best-first or beam search strategy, using a priority queue to store the parse contexts in order of some weight, score, or probability value. Each parse context comprises a synthetic item set (114), which comprises information about synthetic items that have been pushed or are waiting for definition. In some embodiments, there may also be a stack of saved synthetic items (e.g., for handling nested relative clauses). There is also a parse stack (115), as is known for LR parsing using a push-down automaton. The stack may comprise, in addition to saved state labels, semantic information (such as a reference to a knowledge base, semantic network, or lexicon, or a set of logical formulas), the matched input string, flags indicating, e.g., the case of the input, reference resolution information, and/or a set of variable bindings that existed when the node was created. The parse context may also comprise a state label, weight, score, or probability for the parse, information about unknown tokens, information about which actions remain to be performed on the context, flags (e.g., whether the parse context is at the beginning of a sentence), pointer to the input (e.g., offset in the input or pointer to a morpheme graph node), information for reference resolution and disambiguation, variable bindings, new knowledge to be added to the knowledge base, and/or debugging information.

The synthetic item set may be implemented as a list or other data structure of items (each item preferably a struct or object comprising (specifying) a synthetic token identifier and a value corresponding to the token; such value could comprise many fields, such as a parse tree, a semantic description, feature structure for unification, information for long-distance constraints, flags, weight, etc.).

The size of the synthetic item set may be dynamic or fixed. It could be implemented, for example, as a fixed-size table. Many embodiments allow only one instance of each synthetic token to be in the set simultaneously, and then the size is limited to the number of distinct synthetic tokens defined in the grammar (usually there are only a few). In some embodiments the set could even be a simple register capable of containing a single synthetic token and the associated value (in some cases, it would not even be necessary for it to contain an identifier for the synthetic token, as the token would be known if there is only one synthetic token type). The synthetic item set could be implemented as a register or register file in hardware, preferably within a means for representing a parse context (which could be a larger set of registers or a memory area). This specification liberally refers to items and synthetic tokens in the synthetic item set almost interchangeably. The intention in both cases is to refer to an item identifying the particular synthetic token and/or the associated token. However, synthetic tokens in other contexts generally refer to the identifier used for the synthetic token by the parser; usually, this would be a small integer distinct from other such integers used for tokens.

(117) illustrates one or more dialog contexts. The dialog context illustrates a higher-level context for parsing a document or for an interactive dialog. Dialog contexts may also be nested to handle, e.g., quoted speech. In some embodiments the dialog contexts may be merged with parse contexts, or parse contexts may be stored within dialog contexts. There may be many parse contexts associated with a dialog context, but usually only one dialog context associated with each parse context. Dialog context may comprise, e.g., earlier questions and their constituents and values that can be used in reference resolution.

(118) illustrates the parser executor. It is preferably a computer executable program code means, but it may also be a hardcoded state machine on an ASIC or specialized processor. An implementation using an ASIC may be advantageous in mobile or handheld computing devices in order to reduce power consumption. It is generally known how to implement programs or state machines in VLSI.

Parsing generally takes place in the context of a parse context. The parse context comprises state for a particular alternative parse (a non-deterministic parser may be pursuing many alternative parses simultaneously or in sequence). Generally the actions described herein for parsing take place in association with a parse context, even when not explicitly mentioned, and the various synthetic define means and boundary means take a parse context as an input. However, it is also possible to have separate means for each parse context, e.g., in the case of a hardware-implemented parser, particularly if using beam search control where the number of active parse contexts is limited.

The executor usually processes each parse context separately, but may split or merge contexts. It comprises a shift means (119), which implements shift (and goto) actions in the parser, as is known in the art, a reduce means (120), which implements reduce actions, as is known in the art, and triggers the execution of actions associated with rules by the action means (121).

The executor also comprises a synthetic token insertion means (122), which attempts to insert synthetic tokens in response to the contents of the synthetic item set and the cataphoric token list. It may also be responsive to data in the push-down automaton, such as a bit vector indicating in which states a particular token may be shifted or reduced or a bit vector indicating which tokens may be shifted or reduced in a particular state, or to information in parse contexts. It causes the inserted tokens to be processed by the parser executor.

The input to the parser is illustrated by (125). The input may be a text, a scanned document image, digitized voice, or some other suitable input to the parser. The input passes through a preprocessor (126), which may perform OCR (optical character recognition), speech recognition, tokenization, morphological analysis (e.g., as described in K. Koskenniemi: Two-Level Morphology: A General Computational Model for Word-Form Recognition and Production, Publications of the Department of General Linguistics, No. 11, University of Helsinki, 1983), etc., as required by a particular embodiment. It then passes to a morpheme graph constructor (127), which constructs a word graph or a morpheme graph of the input, as is known in the art (especially in the speech recognition art; (126) and (127) may also be integrated). It may also perform unknown token handling. The grammar may also configure the preprocessor and the morpheme graph constructor. Morpheme graph construction is described in, e.g., B.-H. Tran et al: A Word Graph Based N-Best Search in Continuous Speech Recognition, International Conference on Spoken Language Processing (ICSLP'96), 1996 and H. Ney et al: Extensions to the word graph method for large vocabulary continuous speech recognition, IEEE International Conference on Acoustics, Speech, and Signal Processing (ICASSP'97), pp. 1791-1794, 1997, and references contained therein.

The knowledge base (128) provides background knowledge for the parser, usually comprising common sense knowledge, ontology, lexicon, any required speech or glyph patterns, etc. Any known knowledge base or a combination of knowledge/data bases may be used.

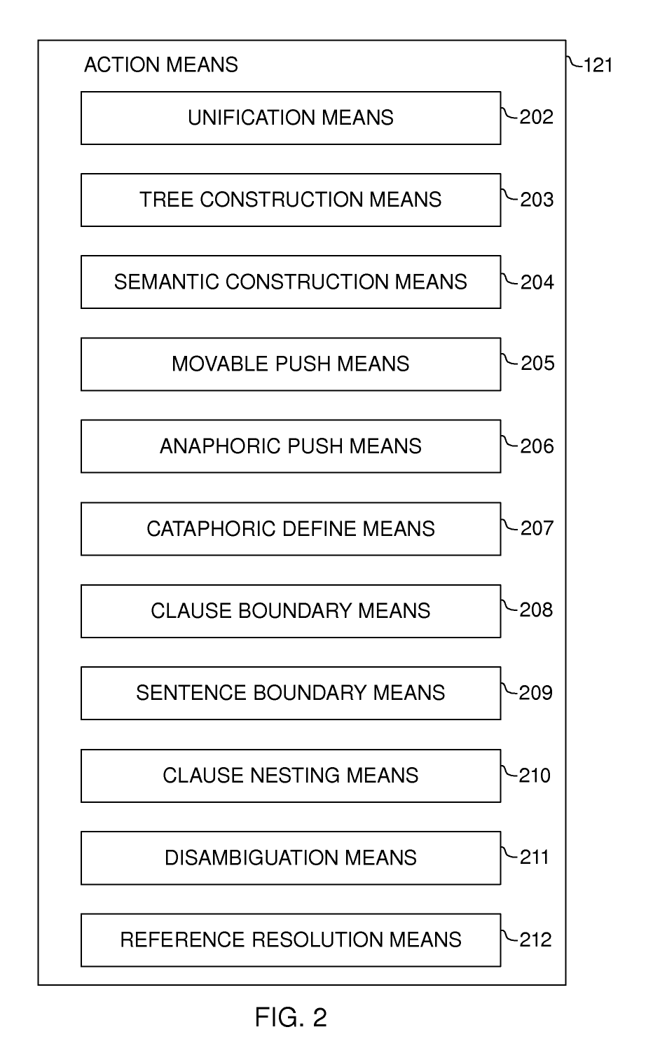

FIG. 2 illustrates the structure of the action means (121) according to an embodiment of the invention. (202) is a unification means for unifying sets of flags, terms, and/or entire feature structures recursively. It may also comprise a means for fetching the required arguments for the unification from the stack in the parse context, the current input token, the knowledge base, or other sources. There are many algorithms for unification; a well-known reference is B. Carpenter: The Logic of Typed Feature Structures: With Applications to Unification Grammars, Logic Programs and Constraint Resolution, Cambridge University Press, 1992.

(203) illustrates a tree construction means for constructing parse trees or abstract syntax trees. It may also include transformations that modify the tree structure or augment the tree structure at a position indicated by a pointer movable through actions. It may not be present in embodiments that construct a semantic description of the sentence directly. In some embodiments it may construct parse graphs by merging parse contexts or using graph-structured stacks (as described in Tomita (1986)).

The semantic construction means (204) constructs a semantic representation of the sentence, preferably independently of a parse tree. The semantic representation may be, e.g., a set of logical formulas, a feature structure, or a semantic network as is known in the art. The semantic representation may be constructed, e.g., in a parse context, in a discourse context, in a work memory area, in the knowledge base, or a combination of these. If the semantic representation is not constructed directly in the knowledge base, it may be moved to or merged with the knowledge base at a later time. Semantic representations may also be merged, especially if graph-structured stacks and/or parse context merging are used. Not all embodiments construct semantic representations.

The movable push means (205), anaphoric push means (206), and cataphoric define means (207) are used for making constituents (and corresponding synthetic tokens) available for synthetic token insertion (these are examples of synthetic define means, i.e., means for making a synthetic token available for insertion based on another constituent in the input and using a value from that constituent). Movable tokens refer to tokens that must be inserted in the current clause; anaphoric elliptic tokens refer to tokens that may be inserted not in the current clause but the next clause, and cataphoric elliptic tokens refer to tokens that may be inserted without having been pushed, but must be later defined in the same sentence. These means are intended for handling actions triggered during parser execution. The actions preferably identify one or more synthetic tokens that may be generated for the pushed constituent. They may also cause an indirection level (e.g., a new node and a SUB or ISA link in a semantic network) to be added so as to avoid, e.g., long-distance constraints for one instantiation from affecting another instantiation. These means could be implemented using a program code means illustrated by the following pseudocode:

elliptic_push(node, token, type) {

data = find_from_synthetic_item_set(token);
if (data != NULL && cataphoric(token))

make the earlier reference(s) indicated in ‘data’

refer to ‘node’;

else

add ‘token’ with value ‘node’ and ‘type’ in the

synthetic item set; }

Making earlier references refer to ‘node’ may be implemented, e.g., by modifying the tree node using a pointer in ‘data’, addition of a formula similar to ‘sub(data.value, node)’, or by having cataphoric insertions create new nodes that are then made to reference ‘node’ by adding a SUB or some other inclusion relation in a semantic network.

It may also be checked whether the parse context should be immediately rejected; for example, trying to push a token when its existing type indicates it must be inserted in the current clause could be considered an error, causing the parse context to be rejected.

When a token is defined (or pushed), the value used for it is usually taken from an earlier (for movable constituents and anaphoric ellipsis) or later (for cataphoric ellipsis) non-synthetic constituent (i.e., a constituent that is not just a synthetic token—though sometimes a value from a synthetic token may be re-pushed).

The clause boundary means (208) reviews the synthetic item set, checking that constituents that must be inserted or defined within the preceding clause have been inserted, and rejecting the parse if any have not. It also turns cataphoric items that may be defined in the next clause into ones that may be defined in the current clause, and items that may be inserted in the next clause into items that may be inserted in the current clause (alternatively, a clause counter and a target clause number in an item could be used to select in which clause to insert/define each item). It also deletes items that could have been inserted in the preceding clause from the set (here it is assumed that elliptic items are removed from the set when inserted, and re-pushed if desired; however, embodiments where they are not removed when inserted and not deleted at clause boundary are also possible).

The sentence boundary means (209) reviews the synthetic item set, and rejects the parse if there remain any items that must be inserted or defined in the current or the next clause. However, there may also be embodiments where the sentence boundary means only modifies a weight factor associated with the items, allowing some violations of strict syntax (same applies to clause boundaries).

The clause nesting means (210) is used for implementing nested clauses such that elliptic or movable tokens may be inserted in either the nested clause or in the higher-level clause after the nested clause. The parse context may comprise a stack of saved synthetic item sets, and the clause nesting means may push the current synthetic item set on this list. It could then prune the synthetic item set such that it only contains those items that must be inserted in the current clause (i.e., movable constituents).

After processing a relative clause, the clause nesting means reviews the synthetic item set, and removes any items which may be inserted in the current or the next clause (unless the next clause is also a connected relative clause), and rejects the parse if there are any undefined cataphoric items in the synthetic item set. For any items that must be inserted in the current clause, it checks whether those items already existed before the beginning of the relative clause (i.e., are in the topmost saved synthetic items set), and if not, rejects the parse; otherwise the item is left on the synthetic items set. Then, any items in the saved synthetic items set, except for those that must be inserted in the current clause, are added to the synthetic item set, and the saved set is popped from the stack.

The clause nesting means could be triggered by actions executed when starting the processing of a relative clause (i.e., entering a relative clause) and when completing the processing of a relative clause (i.e., leaving a relative clause).

The clause nesting means may also limit the nesting of embedded clauses, or decrease the weight of the parse context if nesting becomes very deep, to simulate the difficulty of people in understanding very deeply nested sentence structures.

It should be understood that there is significant flexibility in how the details of synthetic item set handling are implemented. The various filtering, checking, and merging operations described above could be implemented in many ways, and this description is only intended to illustrate one possibility.

The disambiguation means (211) performs word sense disambiguation, scope disambiguation, attachment disambiguation, and/or various other disambiguation operations as is known in the art. An introduction to the disambiguation art can be found from R. Navigli: Word Sense Disambiguation: A Survey, Computing Surveys, 41(2), pp. 10:1-10:69, 2009; E. Agirre and P. Edmonds: Word Sense Disambiguation: Algorithms and Applications, Springer, 2007; S. Hartrumpf: Hybrid Disambiguation in Natural Language Analysis, Der Andere Verlag, 2003; and M. Stevenson: Word Sense Disambiguation: The Case for Combinations of Knowledge Sources, Center for the Study of Language and Information (CSLI), 2003. In many embodiments disambiguation is done as a separate step after parsing, but it may also be performed while parsing.

The reference resolution means (212) tries to resolve the referents of pronouns, proper names, definite noun phrases, and various other constructions in an expression. Various reference resolution methods are described in Proceedings of the Workshop on Reference Resolution and its Applications, Held in cooperation with ACL-2004, 25-26 Jul., Barcelona, Spain, Association for Computational Linguistics (ACL), 2004; and in the book T. Fretheim and J. Gundel: Reference and Referent Accessibility, John Benjamins Publishing Company, 1996. In many embodiments reference resolution is performed as a separate step after parsing, but it may also be performed while parsing.

In the preferred embodiment, the synthetic token insertion means is coupled to the synthetic define means via the synthetic item set. The insertion means will only insert tokens for anaphoric ellipsis if they have already been added to the synthetic item set. Some items may not be fully available for insertion immediately after having been added to the set (e.g., if they can only be inserted in the next clause). The clause boundary means may make such items fully available for insertion, e.g., by changing the value in a type field of such items. The clause boundary means and sentence boundary means are also coupled to the synthetic item set. The clause boundary means will generally reject a parse when it is activated (at or near a clause boundary, typically by a parser action associated with the boundary in the grammar) if a synthetic token that must be inserted in the current clause has not been inserted. The sentence boundary means will typically reject a parse if a synthetic token for cataphoric ellipsis has been inserted but not defined when it is activated at or near a sentence boundary, typically by a parser action associated with the boundary in the grammar.

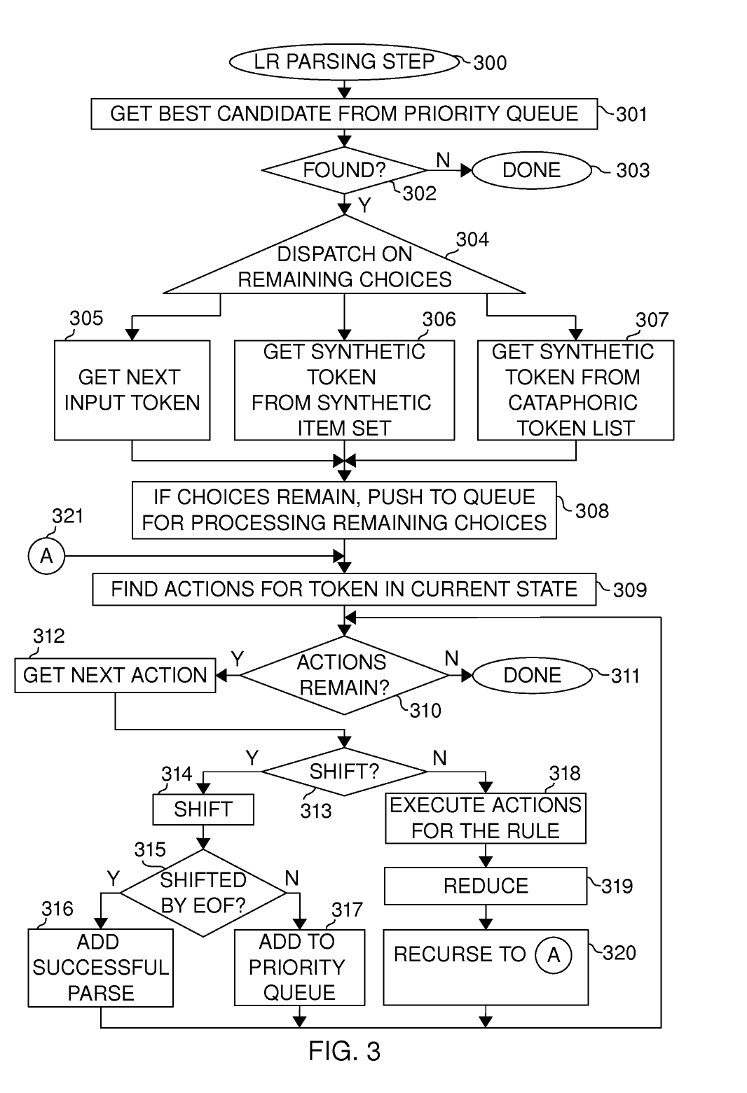

FIG. 3 illustrates LR parsing for a context-free grammar with synthetic token insertion in an embodiment of the invention. The flowchart illustrates one step in a parser using a best-first or beam search strategy (beam search strategy is similar to best-first, but limits the number of candidates to keep at various points); however, non-LR parsers could also be used, and the search strategy need not be best-first or beam search.

(300) illustrates starting a parsing step. Parsing steps would typically be run until a satisfactory successful parse has been found, there are no more candidates (parse contexts) in the priority queue, or a time limit has been exceeded. Before the first step, a parse context pointing to the beginning of the text would typically be added to the priority queue (or at least some of the steps indicated herein would be otherwise performed for the first token).

(301) illustrates obtaining the “best” candidate from the priority queue. “Best” typically means one having highest weight, score, or probability (the exact semantics and definitions of these “goodness” values vary between possible embodiments). Candidates are preferably parse contexts, but there could also be an intermediate data object that serves as the candidate.

(302) checks if a candidate was found, and if not, terminates parsing in (303) (all parses, if any, have already been found).

(304) selects the operation to perform on the parse context from the choices remaining in the parse context. The operation may be advancing (shifting or reducing and then shifting) on an input token or advancing on various kinds of synthetic tokens. There may be, for example, a counter or state field (distinct from the state number in the push-down automaton) indicating which of the actions have already been performed. It is possible to try all possible combinations of insertions and advancements in one call to (300) (using a loop not shown in the drawing), or such counter or state field may be used to indicate which of them have already been tried.

(305) gets the next input token from the morpheme graph constructor (not all possible embodiments use a morpheme graph, though). It may also cause the morpheme graph to be dynamically expanded in some embodiments.

(306) gets a synthetic token (and associated semantic or parse tree data) from the synthetic item set. If the synthetic item set is empty, then this path is not possible. In general, all tokens in the set that may be inserted in the current clause may be tried, one at a time or in parallel. It is said that the token is inserted, since it will be parsed using the relevant parser context as if it had been inserted.

(307) gets a synthetic token from the cataphoric token list. If there are no cataphoric tokens defined in the grammar (the list is empty), then this path is never taken. However, if there is more than one cataphoric token on the list, then they may all be tried, one at a time or in parallel.

(308) pushes the parse context back to the priority queue for processing any remaining choices. Any counter or state field is updated to reflect the choice now being tried. If there are no more possible choices remaining, then it is not added to the queue. (When a parse context is said to be added to the priority queue, it may imply the creation of a new parse context. In some situations, parse contexts may be reused for multiple parsing steps).

(309) looks up actions for the input token or the inserted synthetic token from the push-down automaton from the state indicated in the parse context. Push-down automata for natural language grammars are typically ambiguous, and non-deterministic parsing must be used. Thus, the automaton may specify several actions for the token in each state.

(310) checks if any actions remain for the token in the current state. If none, then processing the token is complete at (311).

Some embodiments may use optimized means, such as bit vectors, already in the selection stage (304) to limit insertions to states or state—next input token combinations that can actually be shifted or reduced.

(312) gets the next action, and (313) checks whether it is a shift or a reduce (note that goto actions are an implementation detail in how the parsing tables are constructed; there could be more than two possible actions here, including goto actions, depending on the embodiment).

(314) handles a shift action (including goto action) in the normal manner (see, e.g., Aho et al (1986) or Tomita (1986)). In addition to pushing the state on the stack, in some embodiments the token, semantic information, the input string from which it was constructed, various morphological or syntactic information or flags, etc., may be pushed with the state. This step may also, e.g., create a new variable to be used as the semantic value of the token, and/or establish a binding for the variable to the token's semantic value in the lexicon.

(315) checks whether the shifted token was the EOF token (end of input is treated as a special “EOF” token in this example, and is the last token received from the input), and if so, adds the parse to the successful parses produced at (316), and if not, adds the parse context to the priority queue at (317) (note that the parse context may be either the same that was taken from the priority queue or a new one, depending on whether it could be reused).

(318) starts handling a reduce action by executing grammar actions associated with the reduced grammar rule (in some embodiments actions could also be associated with transitions, i.e., shifts). The executed actions here mean operations that have been configured to be performed when the rule is reduced, such as parse tree construction, semantic value construction, disambiguation, reference resolution, long-distance constraint enforcement, unification, and the various actions related to synthetic tokens described herein (preferably making use of (205) to (210)).

(319) performs the reduce operation as is known for push-down automata based context-free parsing (see, e.g., Aho et al (1986) or Tomita (1986)). It pops as many tokens from the stack as is the length of the right side of the rule. It then handles the left side of the rule recursively in (320) by performing essentially the same steps as for the input/inserted token in (309)-(320). The recursion entry point is indicated by (321) in the figure, and (311) indicates return from recursion. (317) is replaced by a recursive call for the original token. While this may seem a bit complicated, it is well known in the art; Tomita (1986) contains sample LISP code for implementing non-deterministic LR parsing. The basic idea is just to reduce (i.e., pop stack and shift by the left side) as many times as possible, and after each reduction, if a shift by the input/inserted token is possible, fork the parse context and shift by the token. This is done for all possible combinations recursively, since the grammar is (usually) ambiguous and the automaton is non-deterministic.

The steps starting from (321) (i.e., (309) to 320) generally illustrate processing a token by the parser executor, and are preferably implemented as a subroutine in a program code means, though a hardware state machine with a stack is also a possibility.

Tokens in the system may include, in addition to a token identifier, various semantic and other information, such as matching input string, syntax tree, semantic value, reference to knowledge base, unification feature structure, morphological information, information about possible thematic roles, flags, etc.

There can be several types of movable/elliptic constituents, such as:
constituents which must be inserted in the current clause
constituents which may but need not be inserted in the current clause
constituents which may but need not be inserted in the next clause
cataphorically elliptic constituents which can be inserted at any time (unless already inserted), and must be defined in the next clause.

It is likely that additional types of movable/elliptic constituents will be needed for some new languages. In some embodiments there may be only a single generic mechanism for pushing/defining a synthetic token, with arguments specifying the type of the token, or where it may/must be inserted, whether nested clauses (and what types of nested clauses) can occur between the definition, and whether it may be kept in the synthetic token set across clause or sentence boundaries, possibly with distance constraints (or weight penalty that depends on the distance). The grammar may allow declaring these properties for synthetic tokens. There may also be constraints on how heavy or complex constituents may occur between a push and the corresponding insertion. The clause and sentence boundary actions may take arguments indicating the type of the boundary, and there may be different types of nested sentences. There may also be additional types of boundaries (e.g., for paragraphs, topic switches, turn taking, etc.) and nestings (e.g., for quoted speech).

In the preferred embodiment, the synthetic token is inserted as a token identifier and other information (e.g., semantic content or parse tree), rather than by inserting some string into the input. In many languages, e.g., movable constituents may occur in a different grammatical case in its realized surface location compared to the case where it would occur in its “normal” location where it might be handled by a grammar rule (e.g., nominative vs. accusative).

In some embodiments items may be added to the synthetic item set based on the dialog context, in addition to constituents occurring in the same sentence. For example, a question may make certain elliptic constituents available for insertion in the answer. The sentence boundary marker or a question marker may cause such constituents to be made available. There could also be nesting mechanisms for, e.g., clarifying questions in a dialog, and some elliptic constituents from the question might remain available across such clarifying questions and their answers. A new synthetic define means may be added for adding such constituents into the synthetic item set, e.g., when starting to parse the response to a question.

An advantage of the LR (or LALR) parsing used in the examples is that it is quite fast, particularly if the grammars are “nearly deterministic”. It is often possible to construct even wide-coverage grammars for natural languages that are nearly deterministic. For such grammars, LR parsing can perform very well. There are some context-free grammars that LR parsing cannot handle, but such grammars can be easily avoided in practice. While a lookahead length of 1 was assumed in the examples, it is also possible to use other lookahead lengths, for LR(k), LALR(k), or LL(k) parsing (see Aho et al (1986) for more information on implementing such parsers). Adapting the invention to LL(1) parsing is fairly easy.

One way to apply the invention to chart parsing is to think of the input as a word lattice (as in Collins et al (2004)), and augment the word lattice by optional synthetic token insertions. Such augmentation could involve adding, before each word (token), a subgraph that includes all possible sequences of synthetic tokens that are permitted by the grammar (from zero tokens to all synthetic tokens being added in all orders; though in practice the alternatives can be very much constrained by analyzing the grammar rules to see which sequences of synthetic tokens are actually allowed by the grammar). Parser actions completing the parsing of certain constituents would be associated with actions defining synthetic tokens. The method of Collins et al (2004) could then be used to parse the grammar, with additional constraints rejecting parses that include synthetic tokens but have no corresponding definition for them. Such constraints would preferably be checked early, immediately when merging constituents involving definitions, insertions, and/or clause boundaries, but checking them could also be delayed to final parse tree construction in chart parsers that extract the parses from a table constructed using parsing. The parser executor in that case would be a normal chart parser executor augmented by subgraph insertion means (comprising a synthetic token insertion means), synthetic token define means, and constraint means (comprising the boundary means).

Many variations of the above described embodiments will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

A pointer should be interpreted to mean any reference to an object, such as a memory address, an index into an array, a key into a (possibly weak) hash table containing objects, a global unique identifier, or some other object identifier that can be used to retrieve and/or gain access to the referenced object. In some embodiments pointers may also refer to fields of a larger object.

A computer may be any general or special purpose computer, workstation, server, laptop, handheld device, smartphone, wearable computer, embedded computer, a system of computers (e.g., a computer cluster, possibly comprising many racks of computing nodes), distributed computer, computerized control system, processor, or other similar apparatus whose primary function is data processing.

Computer-readable media can include, e.g., computer-readable magnetic data storage media (e.g., floppies, disk drives, tapes, bubble memories), computer-readable optical data storage media (disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be read by a computer.

A program code means is one or more related processor executable instructions stored on a tangible computer-readable medium, usually forming a subroutine, function, procedure, method, class, module, library, DLL, or other program component.

What is claimed is:

1. A system comprising:
a left-to-right parser executor for natural language;
a synthetic token insertion means configured to insert a synthetic token to be processed by the left-to-right parser executor; and
a synthetic define means coupled to the synthetic token insertion means and responsive to parser actions triggered by the left-to-right parser executor.

2. The system of claim 1, further comprising:
a synthetic item set associated with a parse context;
wherein the coupling is via at least one synthetic item set.

3. The system of claim 1, further comprising:
a clause boundary means configured to reject a parse in response to a synthetic token that must be inserted in the current not having been inserted before the end of the clause in which it should have been inserted.

4. The system of claim 1, wherein the system is a computer.

5. The system of claim 4, comprising at least one synthetic define means selected from the group consisting of movable push means, anaphoric push means, and cataphoric define means.

6. The system of claim 4, further comprising:
a clause boundary means responsive to parser actions performed by the parser executor.

7. The system of claim 4, further comprising:
a clause nesting means responsive to parser actions performed by the parser executor.

8. The system of claim 4, wherein at least one synthetic define means makes available for insertion in a parse context a synthetic token corresponding to a constituent in an earlier question in the dialog context associated with the parse context.

9. The system of claim 4, wherein the left-to-right parser executor implements a generalized LR parser.

10. The system of claim 9, wherein the generalized LR parser is a non-deterministic LALR(1) parser.

11. The system of claim 9, further comprising:
a clause boundary means responsive to parser actions performed by the parser executor.

12. The system of claim 9, further comprising:
a clause nesting means responsive to parser actions performed by the parser executor.

13. The system of claim 9, further comprising:
a sentence boundary means responsive to parser actions performed by the parser executor.

14. The system of claim 9, wherein at least one synthetic define means makes available for insertion in a parse context a synthetic token corresponding to a constituent in an earlier question in the dialog context associated with the parse context.

15. A method of parsing natural language using a left-to-right parser executor in a computer, comprising:
adding, by a parser action performed by the parser executor after parsing a non-synthetic constituent, an item specifying a synthetic token and a value from the non-synthetic constituent into a synthetic item set; and
inserting, by the parser executor, a synthetic token specified by an item in the synthetic item set to be processed by the parser executor.

16. The method of claim 15, wherein a clause boundary means is used to make the added synthetic token available for insertion.

17. The method of claim 15, further comprising:
rejecting, by an action associated with a clause boundary, at least one parse.

18. The method of claim 15, further comprising:
upon entering a relative clause, saving at least some items in the synthetic token set; and
upon leaving a relative clause, restoring at least some items into the synthetic token set.

19. The method of claim 15, further comprising:
adding at least one item specifying a synthetic token and a value for it into the synthetic item set based on at least one constituent of a question stored in a dialog context associated with the parse context associated with the synthetic item set.

20. The method of claim 15, wherein the left-to-right parser executor implements a generalized LR parser.

21. The method of claim 20, wherein the synthetic token in at least one added item is made fully available for insertion by a parser action associated with a clause boundary.

22. The method of claim 20, further comprising:
rejecting, by an action associated with a clause boundary, at least one parse context whose synthetic item set comprises an item that should have been inserted in the preceding clause but was not.

23. The method of claim 20, further comprising:
upon entering a relative clause, saving at least some items in the synthetic item set; and
upon leaving a relative clause, restoring at least some items into the synthetic item set.

24. The method of claim 20, further comprising:
inserting in an embedded clause at least one synthetic token defined in an outer clause.

25. The method of claim 20, further comprising:
inserting at least one synthetic token based on at least one constituent of a question stored in a dialog context.

26. A method of parsing natural language using a left-to-right parser executor in a computer, comprising:
inserting, by the parser executor, a synthetic token to be processed by the parser executor; and
defining, by a parser action performed by the parser executor after parsing a non-synthetic constituent, a value associated with the inserted synthetic token based on the non-synthetic constituent.

27. The method of claim 26, wherein the left-to-right parser executor implements a generalized LR parser.

28. The method of claim 27, further comprising:
rejecting at least one parse context for which for an inserted synthetic token the value has not been defined, in response to an action associated with a sentence boundary.

29. A computer program product stored on a computer readable medium, operable to cause a computer to perform left-to-right parsing of natural language, the product comprising:
a computer readable program code means for causing a computer to add an item specifying a synthetic token and a value for it into a synthetic item set; and
a computer readable program code means for causing a computer to insert a synthetic token specified by an item in the synthetic item set to be processed by the computer as part of the left-to-right parsing.

30. The computer program product of claim 29, further comprising a computer readable program code means for causing a computer to perform generalized LR parsing.

31. The computer program product of claim 30, further comprising:
a computer readable program code means for causing a computer to reject a parse context in response to a movable constituent not having been inserted by the time the end of the clause in which it must be inserted is encountered.

32. A computer program product stored on a computer readable medium, operable to cause a computer to perform left-to-right parsing of natural language, the product comprising:
a computer readable program code means for causing a computer to insert a synthetic token to be processed by the computer as part of the left-to-right parsing; and
a computer readable program code means for causing a computer to define the value associated with the inserted token after parsing a non-synthetic constituent based on the value of the non-synthetic constituent.

33. The computer program product of claim 32, further comprising a computer readable program code means for causing a computer to perform generalized LR parsing.

34. The computer program product of claim 33, further comprising:
a computer readable program code means for causing a computer to reject at least parse context in response to a parser action associated with a sentence boundary.
